(19) United States
(12) Patent Application Publication
(10) Pub. No.: US 2022/0036153 A1
(43) Pub. Date: Feb. 3, 2022

(54) ULTRA LARGE LANGUAGE MODELS AS AI AGENT CONTROLLERS FOR IMPROVED AI AGENT PERFORMANCE IN AN ENVIRONMENT

(71) Applicant: ThayerMahan, Inc., Groton, CT (US)

(72) Inventors: John Andrew O'Malia, Park City, UT (US); Zane Denmon, Noxen, PA (US)

(73) Assignee: ThayerMahan, Inc., Groton, CT (US)

(21) Appl. No.: 17/387,736

(22) Filed: Jul. 28, 2021

Related U.S. Application Data
(60) Provisional application No. 63/057,999, filed on Jul. 29, 2020.

(51) Int. Cl. G06N 3/04; G06F 40/40

(52) U.S. Cl. CPC G06N 3/0427; G06F 40/40

(57) ABSTRACT

Methods and artificial intelligence agents are provided to train or guide an artificial intelligence agent. Visual data and/or text data are received from the artificial intelligence agent and/or an environment of the artificial intelligence agent. A text prompt is generated based on the visual information and/or the text data. The text prompt is provided to an ultra-large language model. Text output of the ultra-large language model is received in response to the text prompt. The artificial intelligence agent is supplied with the text output of the ultra-large language model and/or the text output converted into an alternative format. The artificial intelligence agent is configured to select an action, a series of actions, and/or the policy based on the state of an environment of the artificial intelligence agent and on the text output of the ultra-large language model and/or the text output converted into the alternative format.

### CROSS-REFERENCE TO RELATED APPLICATIONS

This application is a non-provisional of, and claims priority under 35 USC § 119(e) to, U.S. provisional application 63/057,999, filed Jul. 29, 2020, the entire contents of which are incorporated by reference.

### BACKGROUND

### 1. Technical Field

This application relates to artificial intelligence and, in particular, to a bi-directional system enabling Al Agents to consult ultra-large language models (ULLMs) regarding data from an Al Agent's environment, whereby the ULLMs return information, directions, rewards, and/or other data to Al agents so that these may improve the Al agents' performance in the environment. In some examples, the provided methods and systems may also increase the alignment of Al agents and models with human reasoning.

### 2. Related Art

Traditionally, Deep Learning, Reinforcement Learning, and Imitation Learning Algorithms, Models, or Agents (“Agents”), also known as Al Agents or Neural Networks, are designed to take actions and/or make decisions in a given domain in order to attain a reward or achieve a goal, and learn through experience to do this increasingly successfully. Typically, the Agent takes an action, or observes an action or a number of action sequences for a given environment state in the context of a goal, which may be known or unknown to the Agent. See, for example, U.S. non-provisional application Ser. No. 16/154,042, which published as US Patent Application Publication 2019/0108448, entitled ARTIFICIAL INTELLIGENCE FRAMEWORK, which is incorporated herein by reference. The Agent typically evaluates each action and/or observation in the context of the variables the Agent may observe within the environment, and in the context of goals which the agent may perceive or have in the environment. The Agent performs this evaluation in an attempt to learn associations between the actions, observations, and/or goals, to build knowledge about the environment, and to develop increasingly successful strategies, actions, or policies for a given environment state. The training of such Agents is designed to provide enough “reward” or feedback about the relative success of such action sequences for the context provided by the environment state and goal in order to lead to iterative improvement in the Agent's selection of actions for a given environment state. As the Agent learns, the “weights” in the neural network which drive the Agent's observation/action loop are adjusted—often through a process known as backpropagation—in order to improve the quality of future actions and the chances of attaining the goals which the Agent is seeking to reach.

The Al Agent described in U.S. non-provisional application Ser. No. 16/154,042 identified above enables a human operator to direct the learning process of an otherwise-self and/or autonomous-learning Al Agent with natural language and/or a HMI (human-machine-interface), without the human operator possessing technical Al knowledge, and without the constraint of only using previously seen activities and/or scenarios—and, in some cases, feedback thereupon—to shape Agent learning

Nevertheless, in domain-specific contexts, the training of reinforcement learning and/or imitation learning, and/or evolutionary agents, and/or other neural network Agents may be unsuccessful with existing methods and algorithms in some scenarios for various reasons. The reasons that the training may be unsuccessful may include: a relatively high variability in the environment, novel task sets, a relatively large range of potential actions that the agent may take, a difficulty in associating actions with rewards or goals in the environment, or other factors or combinations of factors. In such situations, the neural network of the Agent is unable to sufficiently and/or regularly match a given environment state to an appropriate action in such a way that the neural network of the agent converges to robust matching of actions and environment states with respect to a goal.

The environment may include any component in which, or to which, the Al Agent may carry out actions and/or policies selected by the Al Agent. The environment may include, for example, a video game, a robot, a drone, a vehicle, an aircraft, a watercraft, and any other apparatus and/or software component.

When the Al Agent acts in a given environment, whether in a simulation, the real-world, or a game, the Agent may be at a disadvantage in comparison with human players because the Agent does not have the human ability to (1) reference facts about the observable objects in an environment, and (2) generalize from any of the following: (i) past experience, (ii) the context provided by the environment about the observable objects' likely characteristics, and (iii) how the observable objects may impact goals to be achieved and/or the means to achieve the goals. This human “commonsense reasoning” capability is different from factual knowledge in that this human capability is rooted in generalizable mental models adapted to context and the human actor's understanding of narrative and context, rather than based on static knowledge. Static knowledge graphs do not enable human actors or players in an environment or game to instantly assess or predict object qualities or purposes and gameplay or interaction mechanics, and other characteristics or components in the environment, and how these may relate to goals. Where such assessments are mistaken, the mistaken assessments may be rapidly corrected through experience in the environment, and the mental model adjusted—despite the fact that underlying facts may not have changed. Humans gain such contextual knowledge continually via experience across a vast range of situations, may build abstractive mental models of the relevance of such past knowledge to novel situations, and may generalize across scenarios very fluently. Example 1: in a murder mystery game, a bloody knife is probably a useful and desirable object—a clue—whereas in another game, it is more likely to injure or hurt the player and is best avoided. This is not “knowledge” but inference based on past experience and the context that is presented to the Agent. Such associative capability enables humans to immediately identify likely threats and goals in the environment based on context, and make good choices and rapid progress (on balance) as a result. In some situations, human adherence to past mental models may also be a disadvantage—but on balance human survival itself owes much to the use of mental models and generalization of past knowledge.

Knowledge representation and reasoning is a field of study in Al in which factual information is encoded into a Knowledge Base (KB) that is available to the Agent. This enables the Agent to access and utilize static, factual “realities” of the world in which the Agent acts. This approach has challenges because, in order for such an approach to be effective, the KB must be comprehensive and accurate from the outset, lest it impair the Agent in the Agent's action selection, rather than enhance it. This is particularly the case where changing context may modify the accuracy of information in the KBs, but the KBs do not or structurally cannot take account of the context in which “knowledge” is recorded.

Recent work in the Reinforcement Learning domain (such as WordCraft: An Environment for Benchmarking Commonsense Agents, Jiang et al., 2020) has demonstrated that an Agent may use attention over a static, external semantic knowledge bases (referred to in the Jiang paper as “commonsense knowledge”) pertaining to the objects in its environment and their relationships in order to self-guide its action selection. This method shows improvement over Agents which do not have the ability to access such knowledge bases, but the techniques demonstrated in such papers amount to simple matrix multiplication over objects in the environment and their combinations. The techniques do not provide any contextual inference or generalization via mental models.

This work in the Reinforcement Learning domain validates the thesis that it may be advantageous to the learning and progression of Al Agents over time in some environments to have the capability to gain access to information that humans use. But it also demonstrates that where such information is static and amounts to linear combinations of external facts with in-environment objects, locations, and actions, such techniques do not approach the results of applying human reasoning.

### BRIEF DESCRIPTION OF DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of an Al Agent Controller;

FIG. 2 illustrates an example of operations of the Al Agent Controller; and

FIG. 3 illustrates an example of a native game view and a corresponding abstracted representation.

### DETAILED DESCRIPTION

Methods and systems are provided herein to adapt or generalize past information to the context of the environment in which an Al Agent operates, and the current and/or past states of the environment, and/or to adapt past experience in the context of the narrative of the environment. The component to provide this capability may be referred to as an Al Agent Controller, and this disclosure pertains to methods and systems related to the Al Agent Controller. Al Agents may access such capability to benefit from input provided by the Al Agent Controller to improve the performance of the Al Agents. Improved performance may be in terms of decreased training time, an increased ability to adapt to new situations, an ultimate reward achieved in a given environment for a given number of training steps, or any other common metric for performance in the field of Al.

Unique systems and methods are provided herein which enable information from the Al Agent to be converted into a format that enables the Al Agent Controller to use an Ultra-Large-Language-Model (ULLM) as an engine to process data from the Al Agent and/or the Al Agent's environment, and convert outputs of the ULLM into a format usable by the Al Agent in order to inform the Al Agent's actions within the environment. Surprisingly, this processing may include generalizing past scenarios to new contexts and environments, and/or attributing value to certain goals or actions, and providing guidance or signals or other forms of input to the Al Agent pertaining to the Agent's environment and the choices and actions which may be advantageous to the Agent in that environmental context.

As used herein, an Ultra-Large-Language-Model (ULLM) may be any language model that includes a very large model architecture. A language model may be any data structure representing a statistical model which assigns a probability to a sequence of words. A very large model architecture may include any model having more than a million parameters. The very large model architecture is typically trained with a large training dataset, such as a terabyte or more of English text. Nevertheless, unless otherwise specified, the term Ultra-Large Language Model or ULLM used herein refers to any large language model, and should not be construed to only include an “ultra-large” language model. The training dataset for the ULLM will include data that is unrelated to the specific environment of the Al Agent.

The ULLM may use a class of natural language processing models (such as GPT-3 from OpenAI, introduced in Language Models are Few-Shot Learners, Brown et al., 2020) based on an approach pioneered in BERT: Pre-training of Deep Bidirectional Transformers for Language Understanding (Devlin et al., 2018) which combines a deep learning technique called attention in combination with a deep learning model type known as transformers to build predictive models which encode, and are able to accurately predict, human writing after having been trained on large volumes of written content. With the advent of such very large and models such as GPT-1, GPT-2, and in 2020 the ultra-large-language-model called GPT-3 (all by OpenAl), advances in these architectures began to not only model language on the word level, but successfully model and capture the structure and abstractive capability of human language on a higher level. This novel capability to replicate some of the abstractive capability of human writing enables the use of such models in combination with environment and goal observations to make suggestions which provide the same associative advantages that humans may use when they interact with such environments. The Al Agent Controller may transfer these outputs or suggestions to the Al Agent. Alternatively or in addition, the Al Agent Controller may translate or convert these outputs or suggestions for the Al Agent.

Described herein are methods and systems via which the Al Agent Controller, which may use models in the BERT family of attention/transformer models or other natural language processing models which capture a reflection of human thought, knowledge, associations, and abstractions and generalizations to provide input to the Al Agent in a way that it may affect aspects of the Al Agent's behavior via recommendations regarding the action selection process, salient goals, features, or other attributes, features, or factors in an environment which may influence the behaviors of the Al Agent.

Ultra-Large Language Models are a relatively new class of neural networks which are trained on much larger training data sets than in previous models, and which use a much larger number of parameters than in previous models. Both data processed and parameters trained have increased versus previous models by approximately 10 times. In the case of GPT-3, OpenAl claims to have trained the model using over 65 Terabytes of text data derived from a wide range of sources, including text derived from automatic extraction of data from a variety of sources on the internet. The model is said to have 175 billion parameters. The technique used to train these models is that the model is provided with a text section with certain masked or missing words, and the model is to learn to fill in the “blanks”, or masked words or text sections (“masked” text generation task). In small models, filling in words is possible, but extended text generation by the model tends to become nonsensical. However, with the advent of ULLMs, the capacity of the network and the vast training data sets have resulted in neural networks which model much more high-level information, and have significantly higher capability for abstraction than previous models have demonstrated. This enables the functionality of the novel methods and systems provided herein, which rely on the model's capability of combining certain mental models and thought templates commonly used by people, and successfully adapting them to novel scenarios and data sets. Such models have been shown to be capable of producing extended passages of creative writing such as could be written by a human, based on a very short and simple prompt (“left-to-right” text generation task). The trend toward larger and larger models is certain to continue, given the continued progress in this key area and the prospect for further such advances.

The systems and methods may, through bi-directional information conversion between Al Agent environment and Al Agent Controller/ULLM, enable the Al Agent to use information which may be encoded in the ULLM. In fact, the systems and methods may process information regarding the environment and the information in the context of past experience and mental models derived from, or encoded in, the vast volumes of text used to train the ULLMs. For example, the information regarding the environment may include information about objects within the environment, relationships between the objects, and the relevance of such information to the Al Agent.

The Al Agent Controller may return to the Al Agent, via novel conversion or translation methods, information or guidance, or reward signal(s) regarding elements of the environment, components of the environment, goals, actions, or any combinations thereof which may be relevant or important for any positive or negative reasons. Alternatively or in addition, the Al Agent Controller may return to the Al Agent any other influence or guidance which enables the Al Agent to obtain similar performance benefits that a human may otherwise have had based on the human's use of past knowledge and its generalized application to a given environment/environment state and the goals, objects, relationships, actions and/or other factors which may exist within the environment of the Al Agent.

The provided methods and/or systems enabling an Al Agent to benefit from the encoded mental models and or knowledge in the Al Agent Controller/ULLM may enable the Al Agent to incorporate, or make use of, internal or external knowledge bases, or facts encoded in the Al agent's past training, or other fact-related techniques as part of the Al Agent's capability set. However, in the novel methods and/or systems described herein, such fact-access may pertain to the Al Agent Controller rather than the Al Agent.

The Al Agent accessing the Al Agent Controller for assistance with processing the Al Agent's environment may help to shape the Al Agent's performance selection. The assistance provided by the Al Agent Controller may leverage the extensive training of ULLMs on human mental models, general and generalized knowledge, and associations between components or actions, and their potential application(s) to the Al Agent's environment state. The Al Agent Controller may even be trained or customized for specific domains, in order to enhance the Al Agent Controller predictive power and usefulness to the Al Agent.

The Al Agent Controller may be queried by the Al Agent via our method, and may by virtue of our system's bi-directional information conversion capability acquire or be provided with information regarding the environment and environment state of the Al Agent and components within it, including but not limited to, semantic and other labels, user manuals, human writing or voice content regarding the environment. This information regarding the environment may be exchanged or acquired via any other means and may include its relevance to other scenarios, games, environments, news, media, writing, and other recorded or streamed media.

The Al Agent Controller and the Al Agent may convey information and/or queries to each other and to external systems and modules. This may facilitate the effectiveness of the Al Agent Controller using a range of potential communication methods, and the Al Agent Controller may provide information unsolicited by the Al Agent.

The Al Agent Controller may, via the data conversion and translation methods in our system, provide various inputs to the Al Agent and/or its environment, including but not limited to text-based information, interface overlays, representations, highlights, and any other kind of cue or indication as to positive and negative components, elements, objects, relationships, labels, and other aspects of the Environment which may relate to the Al Agent and—including but not limited to—its actions, goals, environment state variables and/or components, and any combination(s) thereof.

The generalization capability of the proposed Al Agent Controller may be likened to the ability of other neural network approaches where visual and language information are combined to enable the neural networks to extend their outputs to “zero-shot” challenges, in other words, creating outputs for inputs which may lie outside the original data set. An example of this capability may be seen in the paper by Radford et al., 2021: CLIP—Learning Transferable Visual Models from Natural Language Supervision. This paper describes a method called Contrastive Language-Image Pre-training (CLIP) that is an efficient method of learning from natural language supervision. This is a particular example of using image classifiers trained with natural language supervision at a relatively large scale. A relatively large scale means the training dataset may be greater than millions or even tens or hundreds of millions of image/text pairs.

In some examples of teaching deep-learning or deep-reinforcement-learning based Al Agents, the Al Agent performs a series of actions, whether random or directed, and gathers feedback on the effectiveness of the actions in attaining a given reward or goal. This technique may require many thousands, or hundreds of thousands of iterations in order to identify a successful strategy, or may never converge to a successful strategy for a large number of domains and challenges. In the course of such training, the Agent generates a large number of actions that may be at odds with successful play, leading to long training times, high computational resource utilization, and the potential for never reaching an optimal play strategy, as seen in the generic breadth-first, depth-first, and other such action-searching strategies for training Al Agents. This is at odds with the way humans observe and take action in new and challenging environments, because the Agent does not account for contextual knowledge that a human has acquired over time, and which a human may use to apply a general conceptual thought framework, or mental model, to a given task, situation, or environment.

In many environments, Al Agents are unable to appropriately match the state and characteristics of the environment to appropriate decision-making frameworks to successfully reach a given goal, or to correctly infer or reach a sub-goal which may assist it on the way to a goal of which it is aware. This may be considered a problem of “generalization”. An example of this common problem with Al Agents is that they may learn to execute a successful strategy in an environment with certain characteristics, but when relatively trivial changes—from a human perspective—are made to those environmental characteristics, the Al Agent fails to select and execute the correct behavior. The Al industry is actively researching solutions to this problem.

These problems persist for Al Agents which learn through imitation learning, meaning that the Al Agent learns by observing actions of others acting in the environment, and in some cases receiving additional commentary, labeling of the environment or actions/policies, or other forms of feedback. This may lead to faster convergence and more successful learning than the above-described reinforcement learning methods. However, with this approach gaps may arise between what a human intends to demonstrate to the Agent, and that which the Al Agent perceives or learns about the connections between actions and goals and or sub-goals, leading to unsuccessful training. Also, if the scenario or action to be learnt has not already been encountered by or demonstrated to the Al Agent, it may be impossible for the Agent to select a successful action sequence. Furthermore, in many situations a human operator is not available to assist an Al Agent in its learning process, or to manually provide input on action selections, subgoals, or which environment state information the Agent should consider in making its decision.

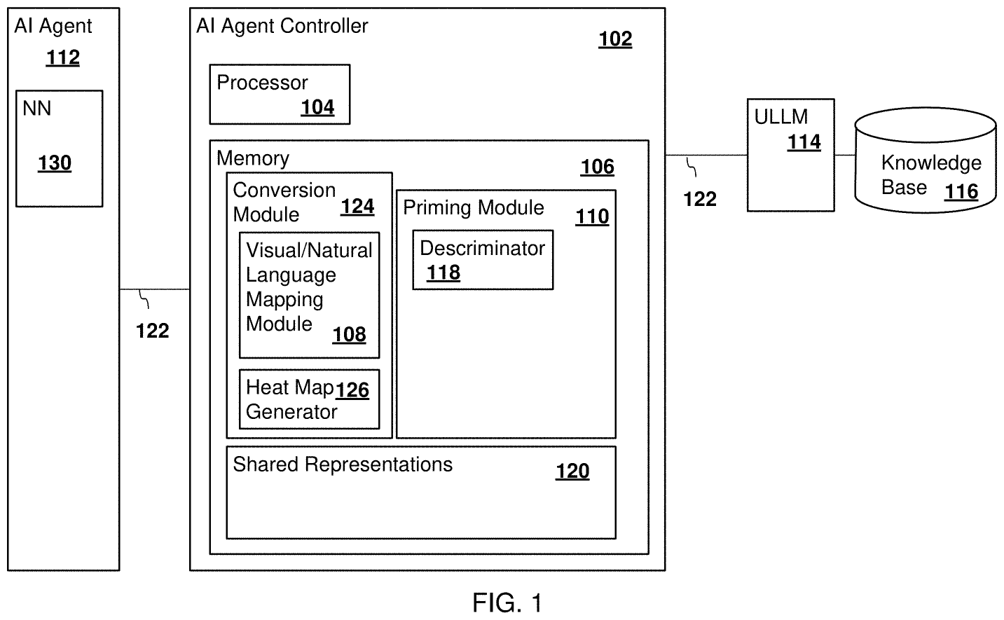

FIG. 1 illustrates an example of an Al Agent Controller 102. In the illustrated example, the Al Agent Controller 102 includes a processor 104 and a memory 106, the memory 106 including a Visual/Natural Language Mapping Module 108, a priming module 110. The Al Agent Controller 102 is configured to communicate with an Al Agent 112. The Al Agent Controller 102 is in communication with an Ultra-Large Language Model (ULLM) 114.

The Al Agent 112 may query the Al Agent Controller 102 which uses the ULLM 114 as an abstraction or generalization engine. Specifically, the Al Agent 112 may use the ULLM 114 to generalize past experiences to the context of current and/or past environment data of the Al Agent 112 or to provide additional context, information, or suggestions as to what action or policy might be most appropriate. The action or policy may be deemed most appropriate based on information or representations—visual or in text or other form—that the Al Agent 112 provides to the Al Agent Controller 102 about current and past observations and action space of the Al Agent 112, as well as perceived goals of the Al Agent 112.

Because most forms of information in environments of the Al Agent 12 may be visual, a method is implemented in which the environment information of the Al Agent 112 is converted into a format which may be processed by the Al Agent Controller 102, and via which the outputs of the Al Agent Controller 102 may be converted into a format which may be understood by the Al Agent. This may include methods to optimize the prompting, or structured querying, of the Al Agent Controller 102 to elicit certain types of responses which may provide particular value to the Al Agent 112.

The Al Agent 112 may share a representation of the environment, or describe an element, or indicate a relationship between elements in an environment, or outline the components of its environment, and provide the information to the Al Agent Controller 102. The Al Agent Controller 102 may generalize the provided information to other, related scenarios or situations so as to propose actions, goals, and/or sub-goals based on the past experience of the Al Agent Controller 102. The experience in this sense means the information encoded during the training of the ULLM 114, and any knowledge base(s) 116 accessible by the ULLM 114. For example, the experience may be included in the text corpus on which the ULLM 114 is trained. The text corpus may only include a relatively small portion of text specifically related to the Al Agent 112 or the environment of the Al Agent 112. In some examples, the text corpus may include no text specifically related to the Al Agent 112 or the environment of the Al Agent 112.

The Al Agent Controller 102 may use multiple aspects of the inputs or prompts to interpret the context of the environment state of the Al Agent 112 such that the Al Agent Controller 102 may generate a relevant output to provide to the Al Agent 112. By incorporating contextual information, the Al Agent Controller 102 may increase the likelihood of the Al Agent 112 selecting an appropriate or useful action and/or recognizing which elements of the environment of the Al Agent 112 may be important to consider when making a decision. Such information from the Al Agent Controller 102 may, once provided in a format that the Al Agent 112 may use, assist with the Agent's ability to disentangle the effects of various factors in the environment, enhancing both current and future action selection.

The Priming Module 110 may be configured to convert visual data such as a digital image to a natural language description of the image, objects in the image, and/or action(s) occurring in the image or series of images. For that purpose, the Priming Module 110 may include and/or utilize the Visual/Natural Language Mapping or captioning Module 108. The Visual/Natural Language Mapping or captioning

Module 108 may be any vision system that outputs a natural language description of an image, objects within an image, and/or action(s) occurring in the image or a series of images. The visual data may include one or more images and/or videos. The Visual/Natural Language Mapping or captioning Module 108 may be configured to receive the visual data directly from the Al Agent 112, or indirectly from the Al Agent 112 via another component such as the Priming Module 110 shown in FIG. 1.

The Visual/Natural Language Mapping or captioning Module 108 may label or caption the visual data using any method known in the art for labeling and/or captioning an image. For example, the Visual/Natural Language Mapping or captioning Module 108 may use the Contrastive Language-Image Pre-training (CLIP) method described further above. In another example, the Visual/Natural Language Mapping or captioning Module 108 may use methods with explicit relational and geometric reasoning components such as Image Captioning: Transforming Objects into Words, 2020, Herdade et al., and methods such as Oscar: Object-Semantics Aligned Pre-training for Vision-Language Tasks, 2020, Li et al. which identify key visual features and then establish semantic alignment between them. Such methods may be used to increase relevant information for the ULLM 114. For example, the relevant information generated by the Visual/Natural Language Mapping or captioning Module 108 may include the relative positioning of objects or entities within the environment, and indications of relationships between objects and/or entities,

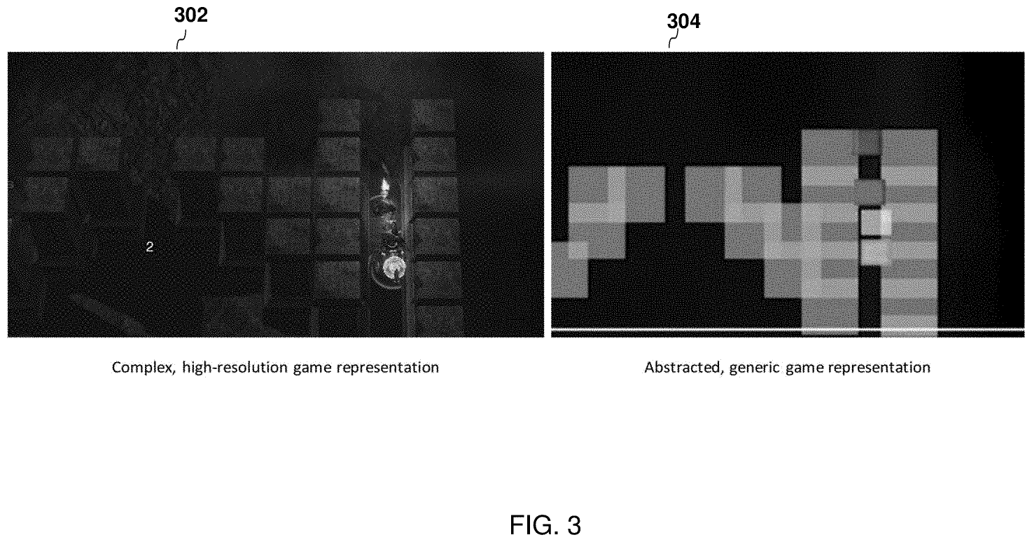

In order to process visual or other data such that the Priming Module 110 may be optimally utilized by the Al Agent Controller 102, or which may include components to handle tabular, text, or other data formats, which may pre-process the data using algorithms or other data-manipulation techniques in order to optimize the data such that the Al Agent Controller 102 may process effectively. An example of such data manipulation may be seen in FIG. 3, where a game screen (Starcraft SC2LE environment, Blizzard/Deepmind) is displayed both in a native game view 302 and in an abstracted representation 304 that may be used generically for games of a certain class. By reducing the game screen complexity to focus on navigational and adversarial components in the abstracted representation 304, the captioning process becomes more consistent across games. This consistency may enable the ULLM 114 and the Al Agent Controller 102 to provide more useful inputs to the Al Agent 112. This ability to generate consistent control signals for the Al Agent 112 may cause the Al Agent 112 to be more successful. Thus, in this context, “optimize” means increasing the success of the Al Agent 112. This general use of data from a wide range of games is what is meant by “effective” processing by the Al Agent Controller 102, because in the absence of the pre-processing to obtain the abstracted representation 304, the captioning process may highlight visual artifacts which are not relevant to action selection.

As noted above, the Priming Module 110 is configured to use the ULLM 114. ULLMs are generally “prompted” or “primed” with text (such as with “masked” and “left-to-right” text generation tasks), and the ULLM is then asked to produce text compatible with the prompt. The Priming Module 110 is configured to generate a text prompt for the ULLM 114 and to provide the text prompt to the ULLM 114. These generated prompts tend to benefit from specific and structured requests, in the sense that such specific requests tend to generate more reliably structured, relevant, and interpretable outputs. The Priming Module 110 is configured to receive a text output from the ULLM 114 in response to the supplied text prompt.

The Priming Module 110 may be optimized to evaluate the relative value and success of the outputs from the ULLM 114 in terms of enhancing the performance of the Al Agent 112 in order to a build a repository of proven mental models or thought templates to which the ULLM 114 responds in a reliable, accurate, and structured way. For example, the Priming Module 110 may include a discriminator 118. The discriminator 118 may be any classifier. In some examples, the discriminator 118 may be included in a generative adversarial network (GAN) included in the Priming Module 110. Alternatively or in addition, the Priming Module 110 may include any other type of reinforcement learning structure and/or an imitation learning structure to evaluate the relative value and success of the outputs from the ULLM 114 in terms of enhancing the performance of the Al Agent 112. The discriminator 118 and/or other learning structure may include a neural network which evaluates whether the output of the ULLM 114 is sufficiently relevant to the inputs of the Al Agent 112 and the environment state of the Al Agent 112 that the output of the ULLM 114 might provide value to the Al Agent 112. The discriminator 118 and/or other learning structure may operate in one or both directions. In other words, the discriminator 118 and/or other learning structure may indicate whether information received from the Al Agent 112 is to be included in the text prompt for the ULLM 114. Alternatively or in addition, the discriminator 118 and/or reinforcement learning structure may indicate whether information received from the ULLM 114 should be passed to the Al Agent 112.

In some examples, the Priming Module 110 may store and utilize Shared Representations 120. Shared Representations 120 are models and templates that, when combined with a given data type or input type from the environment and/or the Al Agent 112, may reliably trigger the application or use of a given thought template, mental model, value system, or similar high-level logical framework by the Al Agent Controller 102. One example class of Shared Representations 120 may be: list completion of things which belong together. Such representations may be activated by the Priming Module 110 and passed as a text prompt to the ULLM 114 in certain situations. As an example, when the Al Agent 112 has or sees a variety of objects in an inventory or on the screen, which may be presented to the ULLM 114 as a list for completion or matching. In such a case, the Priming Module 110 may pass the list to the ULLM 114 for separation or sorting and add a predetermined prompt for “things which belong”. The ULLM 114 may determine the pattern or class that coherently represents some or all of the objects and suggest outputs which continue the pattern. One example is to prompt the ULLM 114 with the first three colors of the rainbow “Red, Orange, Yellow . . . ”, and the model of the ULLM 114 would typically pick up on the nature of the pattern as a shared representation of “things which belong” and map this to color order in a rainbow—although the ULLM 114 may also make other associations. The expected return from the ULLM 114 in this example may be “Green, Blue, Indigo, Violet”. Such information may favorably inform the action selection of the Al Agent 112 in a game without the Al Agent 112 having such direct knowledge or models. Research has shown that the ULLM 114 may understand the nature of such patterns, and fill in the remaining data if such data is available in the model's training data corpus. Likewise, the model may receive a list which a human would naturally separate into two or more classes, and the model would likely return such a set of groupings, using an “Xs and Ys” mental model. The capability of ULLMs to successfully complete such tasks is referred to as “slot-filling”, or is the identification and application of a generic logic model to a specific data problem, whereby the significance of the data points is determined by the ULLM 114 and used adaptively by the ULLM 114 to solve the specific data problem.

The Al Agent 112 and the Al Agent Controller 102 may communicate with each other via q Data Transportation Layer (DTL) 122. The Data Transport Layer 122 may be any communication layer. Examples of the Data Transport Layer 122 may include an application programming interface, a remote procedure call (RPC) layer, SOAP, JSON, TCP/IP, HTTP, or any other communication layer. The Al Agent 112 may record or otherwise capture environment and data received via the Data Transport Layer 122 from the Al Agent 112. The Al Agent 112 may store that data and/or convey that data in (including, but not limited to) tabular, text, or graphic format regarding the environment in which the Al Agent 112 is located, to the Al Agent Controller 102 via the Data Transport Layer 122. The Al Agent Controller 102 may include a conversion module 124 configured to convert information from the environment and/or the Al Agent 112 into a format suitable to submit to the ULLM 114. The Data Transport Layer 122 may capture, manipulate, and transfer data from the Al Agent's environment to the Al Agent Controller 102, and return information, data, and other inputs to the Al Agent and/or its environment or interfaces to that environment. For instance, in Montezuma's Revenge, a snapshot of the environment may be conveyed to the Priming Module 110 via the Visual/Natural Language Mapping Module 108. The Visual/Natural Language Mapping Module 108 may then list likely semantics of the environment and positions of objects on the screen, which when provided to the ULLM 114, may result in suggestions via an interface overlay such as a heatmap which indicates the importance of avoiding the skull and the benefit of acquiring the key. For example, a Heat Map Generator 126 included in the conversion module 124 may generate the heatmap from text returned by the ULLM 114. Any heat map generator may be used for this purpose. An example of a technique for generating such heatmaps is described in Visual Transformers (ViT): An Image is Worth 16×16 Words: Transformers for Image Recognition at Scale, 2021, Dosovitskiy et al., where attention maps are generated over the input image and used to highlight key image areas for a given language prompt. Applications of this heatmap or highlight concept to visual navigation with semantic prompts (such as may come from the ULLM 114 here) are demonstrated in MaAST: Map Attention with Semantic Transformers for Efficient Visual Navigation, 2021, Seymour et al.

The Al Agent 112 may include a neural-network, artificially-intelligent, or deep learning model(s) 130. The models 130 may process information received from the Al Agent Controller 102 regarding potential goals, sub-goals, action-selection prioritization, threats, and contextual and associative and other forms of information, whether visual, text-based, or in other formats. The information may include text and/or visual information, such as a heat map. The model(s) may produce outputs which are interpretable by the Al Agent 112 and may impact on the Al Agent's action selection in the environment over any given time horizon. For details on the model(s) 130 and the Al Agent 112, see for example, U.S. non-provisional application Ser. No. 16/154,042, which published as US Patent Application Publication 2019/0108448, entitled ARTIFICIAL INTELLIGENCE FRAMEWORK.

In a first stage, the Al Agent Controller 102 may be customized for domain-specific uses. Alternatively or in addition, the Al Agent Controller 102 includes or interacts with the ULLM 114, which may be a pre-trained ULLM with general capabilities. A role of the ULLM 114 is to process language-token inputs from the Priming Module 110 in the context of its training data, and produce relevant outputs which may be transferred to the Al Agent 112 to influence its actions. The ULLM 114 may leverage contextual associations of the training data inputs or tokens to which the model of the ULLM 114 has been exposed. Given that ULLMs are typically trained on text corpora which are primarily human writings on a variety of topics, these language models reflect—and to a degree abstract—such human “mental models” and thought patterns. They reflect common human associations. With a prompt such as “I was happy when I saw that the weather was,”, a likely output of the ULLM 114 is “sunny”, or “beautiful.” However, the output of the ULLM 114 may be substantially longer, including long-form text, depending on the prompt and model of the ULLM 114. By interpreting the data provided by the Priming Module 110, the ULLM 114 produces outputs which are consistent with human associations latent in its model weights. In the video game Montezuma's Revenge, such associative outputs mean negative human associations with the environment item “skull” yield low probability of directing the Al Agent 112 to interact with such an element in the environment. This example shows how the Al Agent Controller 102 may generate human associations and map the associations to the Al Agent's environment. As a result, the Al Agent Controller 102 may be dynamic and adaptive, improving performance of the Al Agent 112 in the environment.

In a second Stage, the Priming Module 110, may translate or convert information from the Al Agent's environment into text or text-token format for processing by the ULLM 114. For example, the Visual/Natural Language Mapping Module 108 may generate text from visual information received from the Al Agent's environment.

In order for the Visual/Natural Language Mapping Module 108 to convert visual data from the environment, it may use neural-network based modules or subroutines which perform labeling of a scene represented in the visual data and components of the scene, and/or generate captions, and/or produce data outputs regarding position and relational reasoning between objects in scene. the Visual/Natural Language Mapping Module 108 may use publicly available, general image and or video labeling or captioning systems, or may use custom modules which are tuned or optimized for a specific task or environment.

In a third Stage, the Priming Module 110 may also incorporate optimization processes that condition, translate, or otherwise transform the language representation outputs produced by the Visual/Natural Language Mapping Module 108 before the language representation outputs are transferred to the ULLM 114. For example, the Discriminator 118 of the Priming Module 110 may block or discard certain types of information. This optional third Stage may use data regarding the performance or effectiveness of previous data exchanges between environment of the Al Agent 112 and the ULLM 114 in order to manipulate the data provided to the ULLM 114 in order to improve the likelihood that the ULLM 114 will generate outputs which improve the performance of the Al Agent 112. An example of the conditioning step may include discarding information which is unlikely to be relevant to the Al Agent's decision-making process, or favoring the delivery of novel or changing information which may be more critical to the Al Agent's short-term action selection. The conditioning step may also include the prioritization of information which matches certain key mental models or abstract concepts which the ULLM 114 is deemed or predicted to process effectively, such as certain slot-filling tasks in which a proven ULLM mental model framework may be used to convert a certain type of information into a robust prediction for Al Agent action selection.

The Data Transport Layer (DTL) 122 is the information-transfer system or conduit via which information from the Al Agent 112 and/or the environment of the Al Agent 112 is transferred for processing to the Al Agent Controller 102. The DTL 122 may use a variety of transport options, which may or may not include interim storage of such information, as well as broadcast and/or streaming protocols, as well as any other means of transporting information from one computer system to another. The DTL 122 may transport data between the Al Agent 112 in its environment, and the ULLM 114. The DTL 122 may pass this information through the Priming Module 110 on the way from the Al Agent 112 in its environment to the ULLM 114, and transport data outputs from the ULLM 114 to the Al Agent 112 via the Al Agent Controller 102.

In a fourth stage, the Al Agent Controller 102 may convert text data from the ULLM 114, where such data is not able to be processed by the Al Agent 112, into a form or format in which the information may be used or processed by the Al Agent 112 such that it may influence or improve action selection by the Al Agent 112 in the environment. This fourth stage provides a means of converting the outputs of the ULLM 114, which may take the format of text or text-token or similar formats, into information formats which may be processed or used by the Al Agent 112, where such Al Agents may or may not be able to process inputs in a text format. A simple example might be to provide directional indications, or suggested actions, action tokens, or action types for the Al Agent to follow. A less direct example of such a process using the previous Montezuma's Revenge example is a heatmap- or bounding-box-based output to the Al Agent 112, which uses colors or textures associated by the Al Agent 112 with negative or positive rewards. For example, when the ULLM 114 indicates a negative association with the skull, the Heat Map Generator 126 may highlight the skull to the Al Agent 112 in the color associated with negative rewards. The Al Agent 112 may then process this reward-expectation indication or associate it with a given action or object or location or other element of the environment. This information may be conveyed via visual means, or as data points associated with locations, pixels, or using other information formats which may be processed by the Al Agent 112 in the environment. For a positive expected reward, a path likely to lead to a positive outcome may be indicated in the heat map.

In one unique aspect, the Al Agent Controller 102 uses the ULLM 114 as an abstractive and generalizing engine which encodes human mental models such that for a given input, the Al Agent Controller 102 may measure or score the applicability of a given mental model via the outputs of the ULLM 114 and provide such data to the Al Agent 112. The Al Agent 112 may make decisions as a function of such information.

The Al Agent Controller 102 may perform a bi-directional information conversion and translation method enabling the Al Agent to leverage human knowledge and mental model frameworks which may be encoded in the ULLM 114 of the Al Agent Controller 102, such that the Al Agent 112 may receive data or information via which enables the Al Agent 112 to use or act upon the basis of human knowledge or mental models pertaining to certain elements of the environment and/or the interactions of such elements of the environment.

The Al Agent Controller 102 provides a system which encodes human knowledge and association frameworks in a framework which enables the Al Agent 112 to leverage such knowledge and associations in its action or policy selection(s). Giving the Al Agent 112 the ability to access “commonsense reasoning” is a key unsolved problem in Al systems.

The Al Agent Controller 102 may provide a novel means for the Al Agent 112 to access past human “experience”, encoded in the model via vast volumes of training data used to shape the weights of the network of the ULLM 114, to leverage thought templates for typical human reasoning or thought patterns, and to combine them with new information and context to provide inference related to human thought models, and a mechanism through which such outputs of the ULLM 114 may influence or direct the actions of Al Agent 112 in an environment.

The Al Agent Controller 102 may provide a system for the translation or transformation of visual and/or other data from the Al Agent environment into a format which may be optimized for and processed by the ULLM 114 to provide outputs which may, through presentation to the Al Agent 112, shape Al Agent action selection in a favorable manner, and which may enable the Al Agent 112 to generalize its abilities to more diverse environments than it has seen in the past.

The Al Agent Controller 102 may provide a way for the Al Agent 112 to use semantic or other similarities between environments or environment states which may not be otherwise apparent to the Al Agent 112. This capability may enable the Al Agent 112 to translate or generalize successful strategies from one environment or scenario to another.

The Al Agent Controller 102 may provide human-interpretable natural language and language token data at the Input- and Output layers of the ULLM 114 and a means of observing how the ULLM 114 outputs influence the Al Agent's action selection, creating a novel data source which may enable human observers of the Al Agent Controller 102 to interpret, debug, and improve the functioning of the Al Agent Controller 102 and/or the Al Agent 112. This may advance a key area of Al research, namely interpretability of Al systems.

The Al Agent Controller 102 may enable measurement of the applicability of a given mental model for a given set of inputs from an environment.

The Al Agent Controller 102 may provide a means of translating visual data from the Al Agent environment into language- or language-token-based data such that translated data may be processed by the ULLM 114 to evaluate how such data may relate to human knowledge, mental models, or associations.

The Al Agent Controller 102 may process the output of the ULLM 114 so as to change the output into alternative data formats, overlays, or other data streams which may be processed by the Al Agent 112 in a given environment to influence action or policy selection of the Al Agent 112 as a function of the intent of the ULLM 114 outputs.

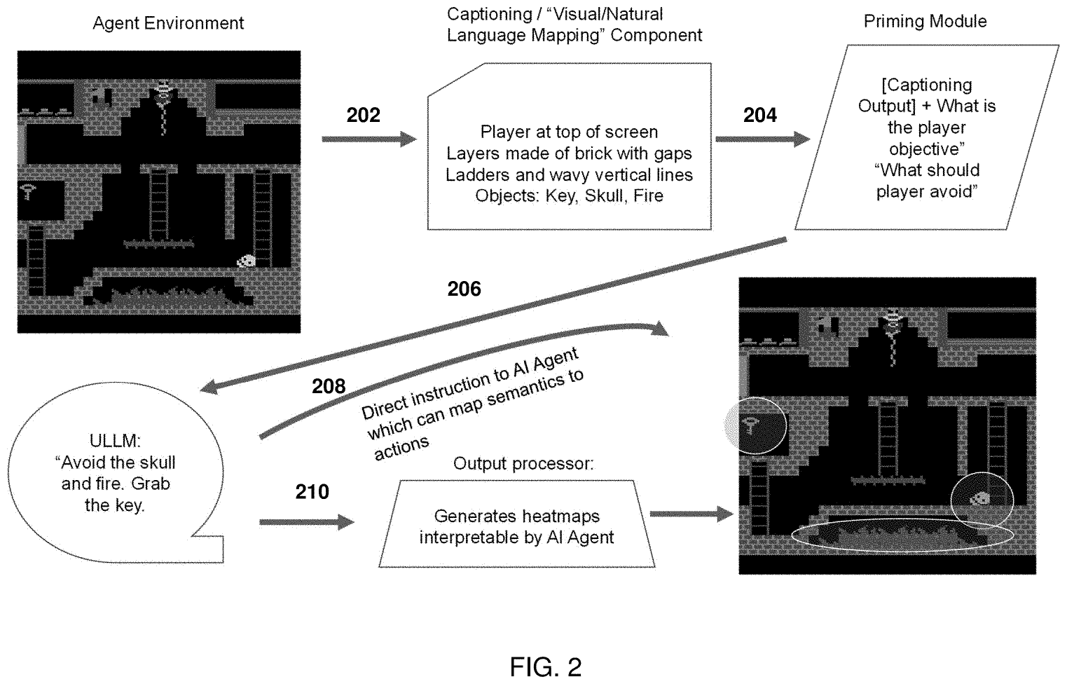

FIG. 2 illustrates an example of operations of the Al Agent Controller 102. Operations may begin with the Visual/Natural Language Mapping Module 108 captioning (202) visual data. In the illustrated example, the visual data is an image received from the environment of the Al Agent 112. In the example, the environment is a video game called Montezuma's Revenge, and the image is a screenshot from the game. The Visual/Natural Language Mapping Module 108 generates captioning text from the image. An example of the captioning text may include:
Player at top of screen
Layers made of brick with gaps
Ladders and wavy vertical lines
Objects: Key, Skull, Fire

Operations may continue by the Priming Module 110 generating (204) a text prompt for the ULLM 114. The Priming Module 110 may generate the text prompt as, for example, the captioning text concatenated with one or more predefined questions, such as “what is the player objective” and “what should player avoid.” The predefined question(s) may be specific to the environment or be relatively generic to multiple environments.

Next, the ULLM 114 may generate (206) output text from the text prompt. For example, the output text may be “avoid the skull and fire” and “grab the key.”

The Al Agent Controller 102 may provide (208) the output text to the Al Agent 112. The Al Agent 112 may map semantics provided in the output text to actions. Alternatively or in addition, the Heat Map Generator 126 may convert (210) the output text from the ULLM 114 into a heat map as shown in FIG. 2. For example, in the heat map, an area around the key may be green, and areas around the fire and the skull, respectively, may be red.

The logic may include additional, different, or fewer operations than illustrated in FIG. 2. Alternatively or in addition, operations may be executed in a different order than illustrated in FIG. 2.

The processor 104 may be in communication with the memory 106. In one example, the processor 104 may also be in communication with additional elements, such as a network interface (not shown). Examples of the processor 104 may include a general processor, a central processing unit, a microcontroller, a server, an application specific integrated circuit (ASIC), a digital signal processor, a field programmable gate array (FPGA), a digital circuit, and/or an analog circuit.

The processor 104 may be one or more devices operable to execute logic. The logic may include computer executable instructions or computer code embodied in the memory 106 or in other memory that when executed by the processor 104, cause the processor to perform the features implemented by the logic. The computer code may include instructions executable with the processor 104.

The memory 106 may be any device for storing and retrieving data or any combination of thereof. The memory 106 may include non-volatile and/or volatile memory. Examples of the memory 106 may include random access memory, read-only memory, erasable programmable read-only memory, and flash memory.

Each component may include additional, different, or fewer components. In the example illustrated in FIG. 1, the priming module 110 is included in the Al Agent Controller 102. However, in other examples, the priming module 110 may be in communication with the Al Agent Controller 102. In some examples, the conversion module 124 is included in the priming module 110. Alternatively or in addition, the discriminator 118 may be external to the Al Agent Controller 102.

The Al Agent Controller 102 may be implemented in many different ways. Each module, such as the priming module 110 and the conversion module 124, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively or in addition, each module may include memory hardware, such as a portion of the memory 106, for example, that comprises instructions executable with the processor 104 or other processor to implement one or more of the features of the module. When any one of the module includes the portion of the memory that comprises instructions executable with the processor, the module may or may not include the processor. In some examples, each module may just be the portion of the memory 106 or other physical memory that comprises instructions executable with the processor 104 or other processor to implement the features of the corresponding module without the module including any other hardware. Because each module includes at least some hardware even when the included hardware comprises software, each module may be interchangeably referred to as a hardware module, such as the priming hardware module and conversion module 124 hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

The processing capability of the Al Agent Controller 102 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL)).

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action includes setting a Boolean variable to true and the second action is initiated if the Boolean variable is true.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

What is claimed is:

1. An artificial intelligence agent controller comprising
a processor;
a priming module configured to receive visual data and/or text data from an artificial intelligence agent and/or an environment of the artificial intelligence agent, wherein the artificial intelligence agent includes a neural network trained to select an action, a series of actions, and/or a policy, which results in an action outputted from the artificial intelligence agent based on a state of the environment of the artificial intelligence agent,
the priming module further configured to generate a text prompt based on the visual information and/or the text data received from the artificial intelligence agent and/or the environment of the artificial intelligence agent,
the priming module further configured to provide the text prompt to an ultra-large language model; and
a data transportation layer configured to supply the artificial intelligence agent with a text output of the ultra-large language model generated in response to the text prompt and/or the text output converted into an alternative format, wherein the artificial intelligence agent is configured to make the selection of the action, the series of actions, and/or the policy based on the text output of the ultra-large language model and/or the text output converted into the alternative format.

2. The artificial intelligence agent controller of claim 1 further comprising a visual/natural language mapping module configured to convert the visual data into caption data including a labeling of a scene represented in the visual data and components of the scene, captions, and/or information indicative of position and relational reasoning between objects in the scene.

3. The artificial intelligence agent controller of claim 2, wherein priming module is configured to generate the text prompt including the caption data and a question.

4. The artificial intelligence agent controller of claim 1 further comprising a heat map generator configured to generate a heat map from the text, wherein the output converted into the alternative format includes the heat map, and wherein the artificial intelligence agent is configured to alter the selection of the action, the series of actions, and/or the policy based on the heat map.

5. The artificial intelligence agent controller of claim 1 further comprising a discriminator including a neural network configured to indicate which information received from artificial intelligence agent is to be included in the text prompt for the ultra-large language model.

6. The artificial intelligence agent controller of claim 1 further comprising a discriminator including a neural network configured to indicate which information received from the ultra-large language model is be passed to the artificial intelligence agent.

7. The artificial intelligence agent controller of claim 1 further comprising a memory including shared representations, wherein the priming module is further configured to generate the text prompt by including a predetermined prompt from the shared representations and a list included in the visual information and/or the text data received from the artificial intelligence agent and/or the environment of the artificial intelligence agent.

8. A computer-implemented method to train or guide an artificial intelligence agent, the method comprising:
receiving visual data and/or text data from the artificial intelligence agent and/or an environment of the artificial intelligence agent, wherein the artificial intelligence agent includes a neural network trained to select an action, a series of actions, and/or a policy, which results in an action outputted from the artificial intelligence agent based on a state of the environment of the artificial intelligence agent;
generating a text prompt based on the visual information and/or the text data;
providing the text prompt to an ultra-large language model;
receiving text output of the ultra-large language model generated in response to the text prompt; and
supplying the artificial intelligence agent with the text output of the ultra-large language model and/or the text output converted into an alternative format, wherein the artificial intelligence agent is configured to select the action, the series of actions, and/or the policy based on the state of the environment of the artificial intelligence agent and on the text output of the ultra-large language model and/or the text output converted into the alternative format.

9. The method of claim 8 further comprising converting the visual data into caption data.

10. The method of claim 9, wherein priming module is configured to generate the text prompt including the caption data and a question.

11. The method of claim 8 further comprising generating a heat map from the text, wherein the output converted into the alternative format includes the heat map, and wherein the artificial intelligence agent is configured to alter the selection of the action, the series of actions, and/or the policy based on the heat map.

12. The method of claim 8 further comprising determining, by a neural network, which information received from artificial intelligence agent is to be included in the text prompt for the ultra-large language model.

13. The method of claim 8 further comprising determining, by a neural network, which information received from the ultra-large language model is be passed to the artificial intelligence agent.

14. The method of claim 8 further comprising generating the text prompt by including a predetermined prompt type and a list included in the visual information and/or the text data received from the artificial intelligence agent and/or the environment of the artificial intelligence agent.

15. A tangible computer readable storage medium comprising computer executable instructions, the computer executable instructions executable by a processor, the computer executable instructions comprising:
instructions executable to receive visual data and/or text data from the artificial intelligence agent and/or an environment of the artificial intelligence agent, wherein the artificial intelligence agent includes a neural network trained to select an action, a series of actions, and/or a policy, which results in an action outputted from the artificial intelligence agent based on a state of the environment of the artificial intelligence agent;
instructions executable to generate a text prompt based on the visual information and/or the text data;
instructions executable to provide the text prompt to an ultra-large language model;
instructions executable to receive text output of the ultra-large language model generated in response to the text prompt; and
instructions executable to provide the artificial intelligence agent with the text output of the ultra-large language model and/or the text output converted into an alternative format, wherein the artificial intelligence agent is configured to select the action, the series of actions, and/or the policy based on the state of the environment of the artificial intelligence agent and on the text output of the ultra-large language model and/or the text output converted into the alternative format.

16. The computer readable storage medium of claim 15 further comprising instructions executable to convert the visual data into caption data.

17. The computer readable storage medium of claim 16 further comprising instructions executable to generate the text prompt including the caption data and a question.

18. The computer readable storage medium of claim 15 further comprising instructions executable to generate a heat map from the text, wherein the output converted into the alternative format includes the heat map, and wherein the artificial intelligence agent is configured to alter the selection of the action, the series of actions, and/or the policy based on the heat map.

19. The computer readable storage medium of claim 15 further comprising instructions executable to determine, by a neural network, if information received from artificial intelligence agent is to be included in the text prompt for the ultra-large language model.

20. The computer readable storage medium of claim 15 further comprising instructions executable to determine, by a neural network, if information received from the ultra-large language model is be passed to the artificial intelligence agent.
